(19) United States
(12) Patent Application Publication
(10) Pub. No.: US 2006/0292349 A1
(43) Pub. Date: Dec. 28, 2006

(54) AN EVAPORATIVE MATERIAL SYSTEM AND METHOD OF MANUFACTURE

(76) Inventor: Frederic Frank Seeley, South Australia (AU)

Correspondence Address: WATTS HOFFMANN CO., L.P.A., 1100 SUPERIOR AVE., STE. 1750, CLEVELAND, OH, 44114, US

(21) Appl. No.: 11/416,772

(22) Filed: May 3, 2006

(30) Foreign Application Priority Data
May 5, 2005 (AU) 2005902444

(51) Int. Cl. B32B 37/00

(52) U.S. Cl. 428/185; 156/210; 156/292

(57) ABSTRACT

A method of manufacturing corrugated paper or similar evaporative media incorporating a liquid spreader block section on a liquid entry side of a core block of media, wherein an additional member is fitted to the core block opposite the spreader block section such that separation of adjacent sheets of corrugated paper within the core block is resisted by the combined presence of the spreader block and the additional member. The additional member is preferably of the same or similar material to that of the spreader block or the main block.

### FIELD OF THE INVENTION

This invention relates to the construction of heat and mass transfer media and, in particular, evaporative media suitable for use in evaporative coolers.

### DESCRIPTION OF THE PRIOR ART

Throughout this description and the claims which follow, unless the context requires otherwise, the word “comprise”, or variations such as “comprises” or “comprising”, will be understood to imply the inclusion of a stated integer or step or group of integers or steps.

The reference to any prior art in this specification is not, and should not be taken as, an acknowledgement or any form of suggestion that that prior art forms part of the common general knowledge in Australia.

Evaporative air coolers are in popular use in most parts of the world where the summer climate is hot and the humidity of the air is relatively low. They are simple in construction, inexpensive to manufacture and operate and can significantly reduce the temperature of air passing through them provided the incoming air has a low level of humidity.

The essential components of an evaporative cooler include a cabinet into which is normally formed a reservoir for storage of water, an evaporative media generally arranged around the periphery of the cooler, a means of circulating water from the reservoir through the evaporative media, and a motor and fan combination arranged such as to draw air through the evaporative media and impel the air into a ducting system for distribution throughout the dwelling or premises. This arrangement subjects the incoming air to intensive evaporation of water within the evaporative media matrix and heat exchange to the water within the evaporative media thus cooled. This mechanism of mass transfer due to evaporation and heat transfer to the cooled water results in the incoming air being cooled to temperatures which can approach the wet bulb temperature of the incoming air. The air is humidified by this process, leaving the evaporative media with higher moisture content than that with which it approached the evaporative media.

Many different constructions of evaporative media have been used throughout the history of evaporative cooling. These include shredded woodwool, horsehair and synthetic fibrous media. However the most popular modern product used as an evaporative medium is a product manufactured from corrugated absorbent paper. This product is assembled from a stack of sheets of corrugated paper arranged such that the direction of corrugations of each alternate sheet are parallel and those of adjacent sheets are inclined to each other. This product is assembled from a stack of sheets of corrugated paper such that adjacent pairs of sheets provide air passages therebetween with water flowing through the sheet material and providing a wicking for the air passages. This construction is particularly effective as an evaporative media because of the intense interaction between the air flowing through the passages and the wetted surfaces of the corrugated sheets as the air flows through the matrix.

The construction of this media results in the airflow through the corrugated channels being separated into distinct channels each channel separated by a piece of corrugated paper with no migration of air flow or water flow between each distinct channel. To be effective as an evaporative cooler medium, it is essential that the air in each distinct channel passes across wetted surfaces within the channel. This can only be achieved if each and every channel is reliably supplied with a water stream during operation of the evaporative cooler. Thus, each and every channel in the media matrix must have a reliable and constant supply of water.

This requirement for reliable wetting implies that the water supply to the evaporative media must be spread uniformly across the top of the media block, thus allowing water to enter, and thus wet, each and every channel. Various devices have been used for this application with varying degrees of success. However, none of these devices has ever been totally successful in providing a uniform supply of water into each and every channel when used with the corrugated paper media, the subject of this application.

Deficiencies in uniformity of water spreading can be compensated by the fitting of a small piece of corrugated medium to the top of the medium block, in which the direction of corrugation is across the block rather than through the block. The fitting of this additional section of medium has the effect of spreading water across the top of the block, thereby producing a more uniform distribution of water to the block of medium than was deliverable by the existing water spreading system. The additional medium is adhered to the top of the medium block by an adhesive, which may be one of many types of adhesive materials available commercially.

The manufacture of corrugate paper media includes the process of gluing the adjacent corrugated sheets together. This is normally done by applying a layer of adhesive to the corrugation crests on one side of a sheet of corrugated paper, and placing this sheet onto the adjacent sheet with the adhesive coated side of one sheet adjacent to the non-adhesive coated side of the other sheet. Adhesion occurs when the crests of the corrugations in adjacent sheets touch, thereby adhesively bonding the sheets together at each touching point. Other methods of adhesion may be used, but adhesion will still only occur at the contact points where crests of corrugations touch, provided adhesive has been adequately applied and the adjacent sheets held in contact for the time it takes for the adhesive to take effect.

The strength and consistency of the adhesive bond between adjacent sheets is most important to the structural integrity of the finished block of media. While randomly scattered points with poor adhesion can be tolerated with little loss of structural integrity, the failure of a substantial portion of a single corrugated sheet to adhere the adjacent sheet results in a line of fracture of the block. Should a line of fracture occur, the block is generally unusable and is scrapped. Instances of this type of adhesive failure are common in the manufacturing process of this product, where it is difficult to maintain total consistency of adhesive application and block processing.

The addition of a small piece of medium across the top of the block for the purpose of improving water spreading has, as a by product, the effect of strengthening the edge to which it is applied. This occurs because the direction of strength of the corrugated paper in the added piece is perpendicular to the sheets in the main block, and has the effect of binding the adjacent layers together regardless of the adhesive quality between the sheets of the main block.

While the addition of a spreader block to the top of the main block of media may improve strength and integrity across the edge to which it is adhered, this is generally not sufficient to recover blocks which have poor adhesion between two adjacent sheets and which break along this plane of weakness. If such breakage occurs, the block of media generally cannot be used even if the adhesion of the main block to the spreader block is maintained. A block with such a deficiency is generally scrapped, even though the defect is minor and does not generally affect the performance of the block once it is installed in its supporting frame in an evaporative cooler.

Media blocks with this adhesion deficiency need not be scrapped if the block could be held together by other means. One such means is to fit a structural member along the edge opposite to the spreader block in such a way that it holds all of the sheets in the main block together thereby preventing them from parting in the event of a deficient adhesive line. Such a means could be a rod or wire arranged such that tensile forces in the rod or wire hold the sheets of the main block with a slight compressive force.

However, a practical and effective method of preventing deficient adhesive lines in the main block from parting is to fit another block of similar dimensions and the same orientation as the spreader block to the edge of the main block opposite the spreader block. Such a “footer” block can be adhered by the same means as for the spreader block. When so constructed, the footer block will hold the sheets of the main block together in the same way as that the spreader block holds the top edge of the main block together, and prevent fracture lines regardless of the integrity of the adhesive between individual lines in the main block.

Furthermore, this method of construction can be implemented with little, if any additional cost. For a predetermined overall size of evaporative pad, the main block of the pad can be made smaller by the dimension of the footer block, thereby saving a proportionate amount of material and cost in the manufacture of the main block. Since the spreader block, and the footer block of similar dimensions, are generally made from off-cuts of block material which would be otherwise scrapped. The operation of fitting the footer block can be readily incorporated into the operations for fitting the spreader block. The only additional material cost is the additional adhesive between the main block and footer block.

### SUMMARY OF THE INVENTION

A method of manufacturing corrugated paper or similar evaporative media incorporating a liquid spreader block section on a liquid entry side of a core block of media, wherein an additional member is fitted to the core block opposite the spreader block section such that separation of adjacent sheets of corrugated paper within the core block is resisted by the combined presence of the spreader block and the additional member.

Said additional member is preferably of the same or similar material to that of the spreader block or the main block.

### BRIEF DESCRIPTION OF THE DRAWINGS

The present invention will now be described by way of example with reference to the accompanying drawings, in which:

FIG. 1 is an isometric view of a known core block of corrugated paper evaporative media;

FIG. 2 is an isometric view of a known variant of a block of corrugated paper evaporative media of the embodiment of FIG. 1;

FIG. 3 is an isometric view of the core block of FIG. 2 showing a mode of failure as a result of defective manufacture; and

FIG. 4 is an isometric view of a preferred embodiment of a block of corrugated paper evaporative media in accordance with the present invention.

### DESCRIPTION OF EMBODIMENTS

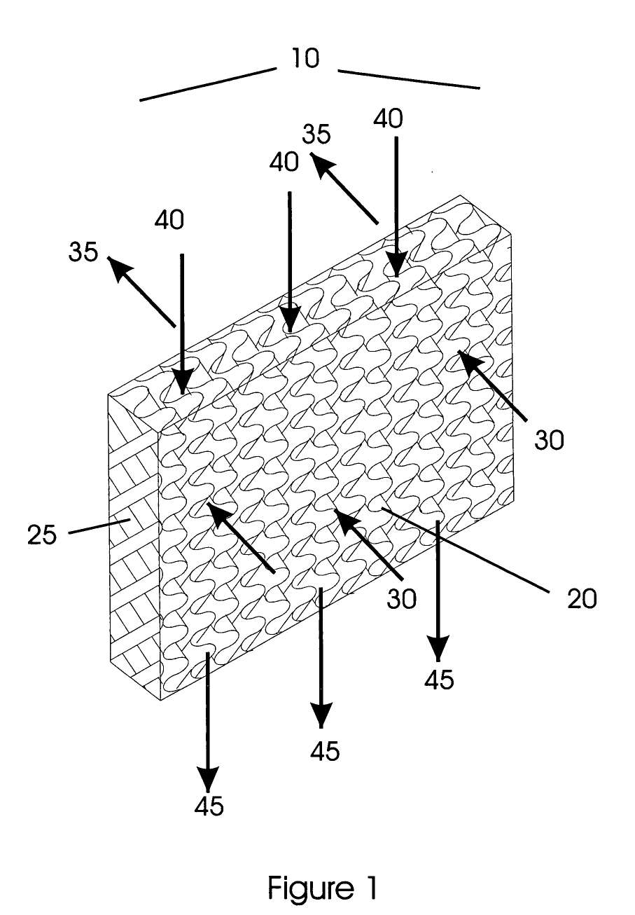

In FIG. 1, the media block 10 is constructed from individual corrugated sheets 20 arranged such that alternating sheets 20 have opposite flute angles as illustrated on the end plane 25 of the media block. 10. The individual sheets 20 are glued together with an adhesive during manufacture resulting in the complete media block 10.

In operation as an evaporative media block, water enters the top of the media block 10 as shown at 40. Water travels in a generally vertical direction through the block, wetting the internal surfaces of the block as it flows, finally exiting at 45. Hot dry air enters one of the vertical faces of the media block at 30, and is cooled and moistened as it travels through the block before exiting at 35.

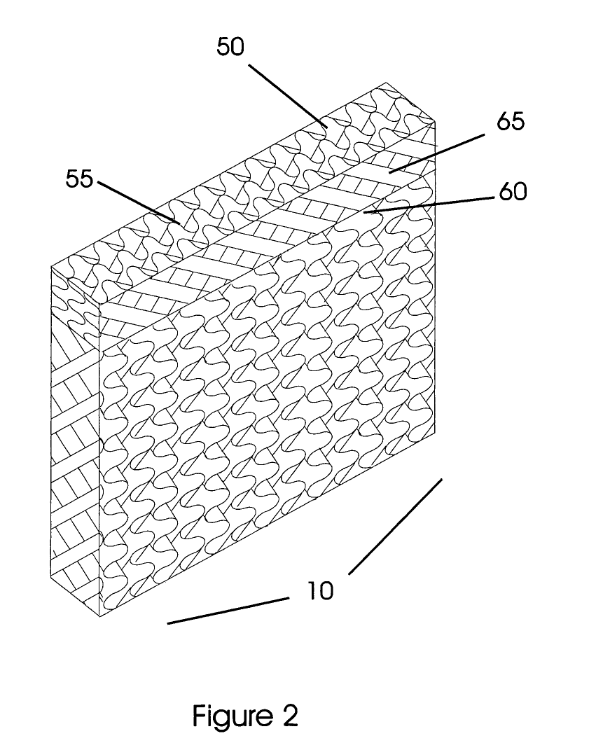

The performance of the media block 10 is enhanced by the addition of a spreader block 50. The spreader block 50 is generally constructed from similar material to the main block 10, but arranged such that the direction of the sheets of corrugated paper 55 run at right angles to the corrugated sheets in the main block as shown in FIG. 2. The angles of corrugation in the spreader block are shown on plane 65. The spreader block 50 is glued to the main block 10 along glue line 60.

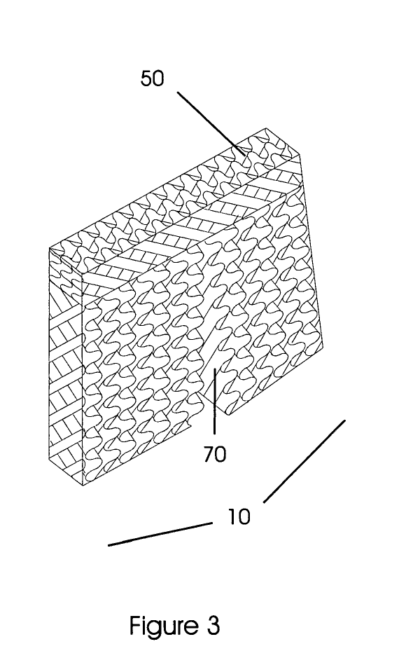

FIG. 3 shows the result of a weak adhesion line between adjacent sheets of the main block. The line of weakness occurs at 70 in which one sheet has failed to adhere to the next sheet. The block is able to open up as illustrated, even though the top edge is kept intact by the spreader block 50. A block in this condition generally cannot be used and is scrapped.

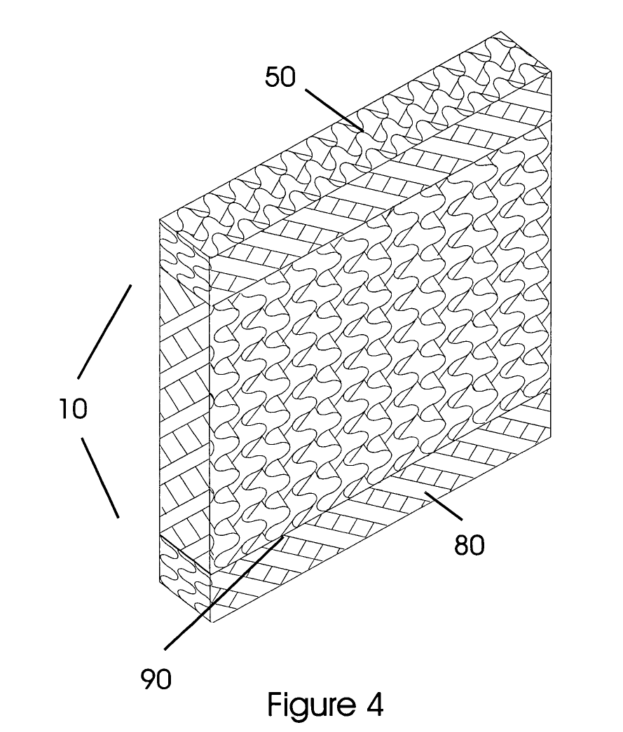

In FIG. 4, and additional block similar in size, shape and orientation to the spreader block 50 has been added as a footer block 80. In this configuration, the footer block 80 provides similar strength and support to the main block 10 as is provided by the spreader block 50. Should a line of weakness occur as depicted by 70 in FIG. 3, the main block is prevented from opening up and can still fulfil its function as a wettable media.

The preferred embodiment of the invention is illustrated in FIG. 4 in which the footer block 80 provides the support necessary to prevent the main block 10 from opening up in the case of a weak adhesion line within the main block. The preferred material for the manufacture of the footer block is the same or similar to that used for the manufacture of the main block. The preferred method of manufacture is the same or similar method of manufacture used to attach the spreader block 50.

In an alternative embodiment, the footer block 80 could be replaced by any member capable of providing tensile strength whilst preventing the opening of any sheets of the main block with weak adhesive lines. Those skilled in the art will recognise that such a function could be provided by, for example, a wire member suitably formed to shape, a plastic moulding formed to grip the edges of the main block or a single sheet of flat paper glued in the position of glue line 90.

1. A method of manufacturing corrugated paper or similar evaporative media incorporating a liquid spreader block section on a liquid entry side of a core block of media, wherein an additional member is fitted to the core block opposite the spreader block section such that separation of adjacent sheets of corrugated paper within the core block is resisted by the combined presence of the spreader block and the additional member.

2. A method as claimed in claim 1, wherein said additional member is of the same or similar material to that of the spreader block.

3. A method as claimed in claim 1, wherein the additional member is of the same or similar material to that of the core block.

4. A method as claimed in any one of the preceding claims, wherein the additional member is a block of the core material adhesively fixed to the core block.

5. A method as claimed in any one of the preceding claims, wherein the airflow passages in the additional member are aligned orthogonally to airflow passages in the core block.

6. A method as claimed in claim 1, wherein the additional member is a flat sheet adhered to the core block.

7. A method as claimed in claim 1, wherein the additional member is a member shaped to be retained in contact with a perimeter of the core block on a water exit side of the core block.

8. A block of corrugated paper or similar evaporative media when formed by a method of any one of the preceding claims

9. A method of manufacturing a corrugated paper or similar evaporative media substantially as hereinbefore described with reference to FIG. 4 of the accompanying drawings.

10. A block of corrugated paper or similar evaporative media substantially as hereinbefore described with reference to FIG. 4 of the accompanying drawings.
